(19) United States
(12) Patent Application Publication
(10) Pub. No.: US 2003/0191819 A1
(43) Pub. Date: Oct. 9, 2003

(54) Client aware notification in a wireless portal server

(76) Inventors: Luu Tran, Santa Clara, CA (US); Jacques Belissent, East Palo Alto, CA (US)

Correspondence Address: WAGNER, MURABITO & HAO LLP, Third Floor, Two North Market Street, San Jose, CA, 95113, US

(21) Appl. No.: 10/116,231

(22) Filed: Apr. 4, 2002

(51) Int. Cl. G06F 15/16

(52) U.S. Cl. 709/219

(57) ABSTRACT

Embodiments of the present invention relate to a method and apparatus for communicating using a wireless portal server. The wireless portal server is communicatively coupled with at least one wireless network for sending and receiving communications over the wireless network. The wireless portal server is also communicatively coupled to service providers for providing content to wireless-network users over channels of the wireless portal server. The wireless portal server is operable upon receiving a communication from a client device that indicates a wireless-network user that is to receive the communication to automatically couple the communication to the wireless-network user according to preferences indicated by the wireless-network user.

### FIELD OF THE INVENTION

The present invention relates to the field of communication apparatus and methods. Embodiments of the present invention relate to apparatus and methods for communicating using a portal server.

### BACKGROUND OF THE INVENTION

A portal server provides means for users to access multiple sources of information and services via the Internet. More particularly, service providers deliver information to the client via “channels” that are accessed via the portal server. A typical portal server includes portal server software that is operable on one or more computing devices.

Users contact the portal server using a client program (the requesting program associated with the user). Typically the client program is a web browser or other program operable on the client's computing device. The client program requests web pages (e.g., HTML pages or files) from the portal server. The portal server then provides the requested web pages, either from its own data storage or through access to resources of service providers.

The use of wireless communication devices (e.g., cellular telephones, paging devices and Personal Digital Assistants (PDAs)) has increased dramatically in recent years. As a result many users of wireless communication devices can be reached via multiple communication mechanisms. However, persons attempting to contact the user of a wireless communication device are often unaware of the different mechanisms for communicating with the receiving party. When the sender is aware of the different ways to reach the wireless communication device user, it is time consuming to keep track of all the devices, numbers and other information necessary to communicate with each of the user's communication devices. This is complicated by frequent changes in service plans (e.g., new cell phone numbers) and frequent hardware updates. In addition, there is no way to determine which communication device should be used at any one time to reach the user.

Thus, there is a need for a method and apparatus that will allow a user to easily communicate with a receiving party that has a wireless communication device and that can be reached by more than one communication mechanism. The method and apparatus of the present invention provides a solution to the above need.

### SUMMARY OF THE INVENTION

The method and apparatus of the present invention use a portal server for coupling communications between a user and a receiving party. The portal server determines the best way to couple the communication to the receiving party and automatically sends the communication to the receiving party. Thereby, the method and apparatus of the present invention allow a user to easily communicate with a receiving party.

A portal server is disclosed that is communicatively coupled with at least one wireless network for providing Internet access to wireless-device users. The portal server is also communicatively coupled to service providers for providing content to wireless-network users over channels of the portal server. The portal server is operable upon receiving a communication from a client device that indicates a wireless-network user that is to receive the communication to automatically couple the communication to the wireless-network user according to preferences indicated by the wireless-network user.

A method for communicating using a portal server that is coupled to at least one wireless network is also disclosed. In this method, upon receiving a communication that indicates a wireless-network user that is to receive the communication, the portal server automatically determines how to send the communication to the wireless-network user. The portal server then sends the communication to the wireless-network user.

In one embodiment the method includes receiving data at the portal server that identifies one or more communication devices that can be used to couple communications to the wireless-network user (communication device data). The communication device data is then stored in a data storage device that is communicatively coupled to the portal server. The wireless-network user is allowed to indicate preferences between the communication devices (which are also stored). The communication device data and the preferences are then used to automatically determine how to send the communication to the wireless-network user.

Thereby, the method and apparatus of the present invention allow the wireless-device user to be reached using multiple communication devices while making it easy for the sender of the communication. Also, the sender of the communication does not have to keep track of each of the wireless-device user's communication devices, numbers and other information required to reach the wireless-device user. Moreover, the wireless-device user can choose how to be reached, making sure that the wireless-device user promptly receives desired communications.

### BRIEF DESCRIPTION OF THE DRAWINGS

The operation and components of this invention can be best visualized by reference to the drawings.

FIG. 1 illustrates a wireless portal server network in accordance with one embodiment of the present invention.

FIG. 2 illustrates an exemplary computer system in accordance with one embodiment of the present invention.

FIG. 3 illustrates functional components of a wireless application environment in accordance with one embodiment of the present invention.

FIG. 4 is a flow chart that illustrates a method for communicating using a wireless portal server in accordance with one embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention. At times, concepts disclosed in this discussion of embodiments of the present invention will be made more readily apparent in reference to the Figures.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic information capable of being stored, transferred, combined, compared, and otherwise manipulated in a computer system. It has proven convenient at times, principally for reasons of common usage, to refer to these information as transactions, bits, values, elements, symbols, characters, fragments, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving,” “determining,” “sending,” “storing,” “indicating” or the like, refer to actions and processes of a computer system or similar electronic computing device. The computer system or similar electronic computing device manipulates and transforms data represented as physical (electronic) quantities within the computer system memories, registers or other such information storage, transmission or display devices.

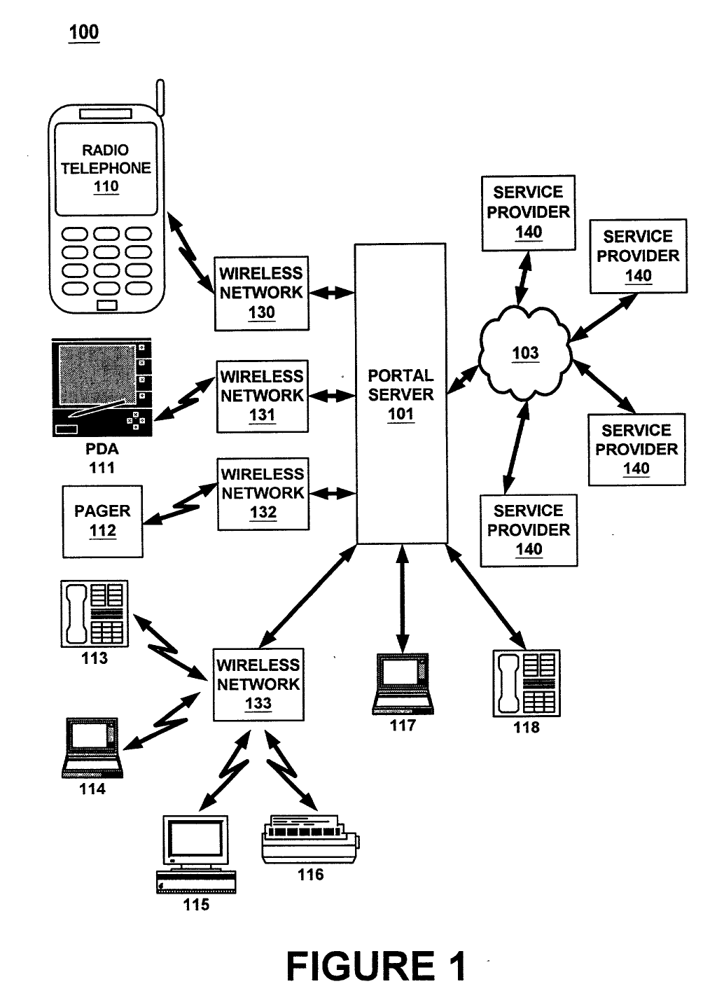

FIG. 1 shows an exemplary wireless portal server network 100 that includes wireless portal server 101. In the present embodiment, wireless portal server 101 is a portal server that provides services to wireless-device users. In one embodiment, wireless portal server 101 is a portal server that only provides services to wireless-device users. However, in one embodiment, these wireless-device users can obtain services from and communicate with wireless portal server 101 using both wireless communication methods and non-wireless communication methods.

In the present embodiment, wireless portal server 101 provides content or “channels” from service providers 140-143. These channels are made available to wireless-device users through the use of communication devices 110-116 by communication through wireless networks 130-133. In one embodiment, channels are also made available to users through communication devices 117-118 that are not wireless devices and that are not coupled to any wireless network.

Communication devices 110-116 include wireless-communication devices and non-wireless communication devices that are wirelessly linked to portal server 101. Continuing with FIG. 1, examples of wireless-communication devices that are illustrated include radio telephone 110, Personal Digital Assistant (PDA) 111, pager 112, telephone 113, portable computer 114, desktop computer 115 and facsimile device 116. It is appreciated that communication devices 110-116 are exemplary and that other types of communication devices could also be wirelessly linked to portal server 101.

Radiotelephone (e.g., a cellular telephone 110) is coupled to wireless portal server 101 via wireless network 130. More particularly, radiotelephone 110 is wirelessly coupled to wireless network 130. Wireless network 130 is coupled to wireless portal server 101 by the communication pathway indicated by arrow 150.

Personal Digital Assistant (PDA) 111 is coupled to wireless portal server 101 via wireless network 131. More particularly, PDA 110 is wirelessly linked to wireless network 131. Wireless network 131 is coupled to wireless portal server 101 by the communication pathway indicated by arrow 151.

Pager 112 is coupled to wireless portal server 101 via wireless network 132. More particularly, pager 112 is wirelessly linked to wireless network 132. Wireless network 132 is coupled to wireless portal server 101 by the communication pathway indicated by arrow 152.

Continuing with FIG. 1, wireless network 133 is coupled to wireless portal server 101 by the communication pathway indicated by arrow 153. The communication devices wirelessly linked to wireless network 133 include telephone 113, portable computer 114, desktop computer 115 and facsimile device 116. Devices 113-116 can be stand-alone communication devices or can include a radio modem or other similar device for providing wireless communication abilities.

Communication pathways 150-153 couple wireless networks 130-133 to portal server 101. Communication pathways 154-158 couple wireless portal server 101 to the Internet and to service providers 140-143. Communication pathways 150-158 can include the Internet and any of a number of different communications systems such as the Plain Old Telephone System (POTS), wireless communication systems (e.g., cellular telephone communication systems and paging systems) and may include one or more Local Area Network (LAN), Wide Area Network (WAN), or other communication system, and may use Ethernet, Transmission Control Protocol/Internet Protocol (TCP/IP), hypertext Transfer Protocol (HTTP) or other communication protocol.

In the present embodiment, wireless portal server 101 is coupled to communication devices 117-118 by the communication pathways indicated by arrows 159-160. More particularly, wireless portal server 101 is coupled with portable computer 117 by the communication pathway indicated by arrow 159. Wireless portal server 101 is coupled with telephone 118 by the communication pathway indicated by arrow 160. In the present embodiment communication pathways 159-160 are non-wireless communication pathways such a conventional telephone land line. Communication pathways 159-160 can include the Internet and any of a number of different communications systems such as the Plain Old Telephone System (POTS), and may include one or more Local Area Network (LAN), Wide Area Network (WAN), or other communication system, and may use Ethernet, Transmission Control Protocol/Internet Protocol (TCP/IP), hypertext Transfer Protocol (HTTP), wireless access protocol (WAP) or other communication protocol.

Though the embodiment of FIG. 1 shows service providers 140-143 to be linked to wireless portal server 101 via the Internet 103, one or more of service providers 140-143 could also be directly linked to wireless portal server 101 through a communication link that does not include the Internet. Similarly, some or all of wireless communication devices 110-116 could be directly wirelessly linked with portal server 101.

In the present embodiment, wireless portal server 101 provides a wireless application environment that specifies an environment that allows service providers 140-143 and operators of wireless networks 130-133 to build applications and services that can reach a wide variety of different platforms (e.g., communication devices 110-118). Requirements for communicating and providing services within the wireless application environment are specified, allowing for communication between wireless-device users and providers of services useful to wireless-device users.

Wireless portal server 101 of FIG. 1 is disclosed to provide communication for wireless-communication-device users when wireless-communication-device users are operating wireless-communication devices. However, those wireless-communication-device users can also communicate using communication devices that are not wireless-communication devices and using communication pathways that do not include wireless communication pathways. Thereby, wireless-device users having multiple communication devices can use all available communication devices for accessing services from portal server 101.

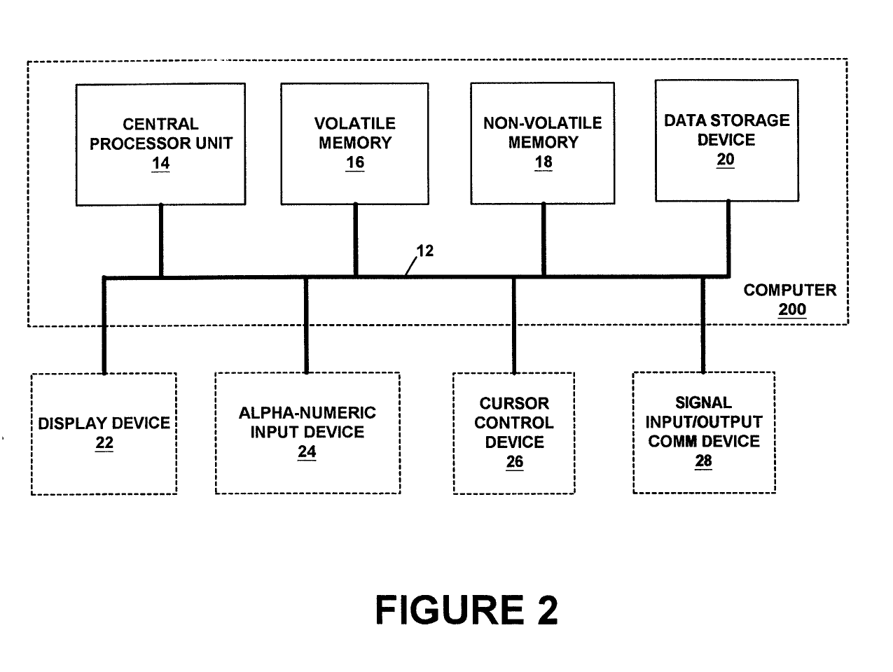

FIG. 2 shows an exemplary computer system 200 used by embodiments of the present invention. In general, computer system 200 of FIG. 2 includes an address/data bus 12 for communicating information and one or more central processor unit 14 coupled with bus 12 for processing information and instructions. Central processor unit 14 may be a microprocessor or any other type of processor. Computer system 200 also includes data storage features such as a computer usable volatile memory unit 16 (e.g., random access memory, static RAM, dynamic RAM, etc.) coupled with bus 12 for storing information and instructions for processor(s) 14.

Continuing with FIG. 2, optional signal input and output device 28 is coupled with bus 12 for enabling system 200 to interface with other electronic devices. In one embodiment of the present invention, input and output device 28 is a serial communication port, but could also be any number of well known communication standards and protocols, e.g., Universal Serial Bus (USB), Ethernet, FireWire (IEEE 1394), parallel, small computer system interface (SCSI), infrared (IR) communication, Bluetooth wireless communication, modem, wireless modem, etc.

Computer system 200 also includes a data storage device 20 (“disk subsystem”) such as a magnetic or optical disk and disk drive coupled with the bus 12 for storing information and instructions. In the present embodiment, data storage device 20 includes one or more removable magnetic or optical storage media such as disk drives, magnetic tape, CD's etc.

Optionally, computer system 200 can include a display device 22 that is coupled to bus 12 for displaying graphics and/or video. It should be appreciated that optional display device 22 can be a cathode ray tube (CRT), flat panel liquid crystal display (LCD), field emission display (FED), or any other display device suitable for displaying video and/or graphic images and alphanumeric characters recognizable to a user. Furthermore, system 200 can include an optional alphanumeric input device 24 including alphanumeric and function keys coupled to the bus 12 for communicating information and command selections to the central processor(s) 14.

Additionally, the computer system 200 of FIG. 2 can include an optional cursor control device 26 coupled to the bus 12 for communicating user information and command selections to the central processor(s) 14. Cursor control device 26 allows the computer user to dynamically signal the two-dimensional movement of a visible symbol (pointer) on a display screen of display device 22. Many implementations of the cursor control device are known in the art including a trackball, mouse, joystick or special keys on alphanumeric input device 24 capable of signaling movement of a given direction or manner of displacement. It is to be appreciated that the cursor control 26 also may be directed and/or activated via input from the keyboard using special keys and key sequence commands. Alternatively, the cursor may be directed and/or activated via input from a number of specially adapted cursor directing devices.

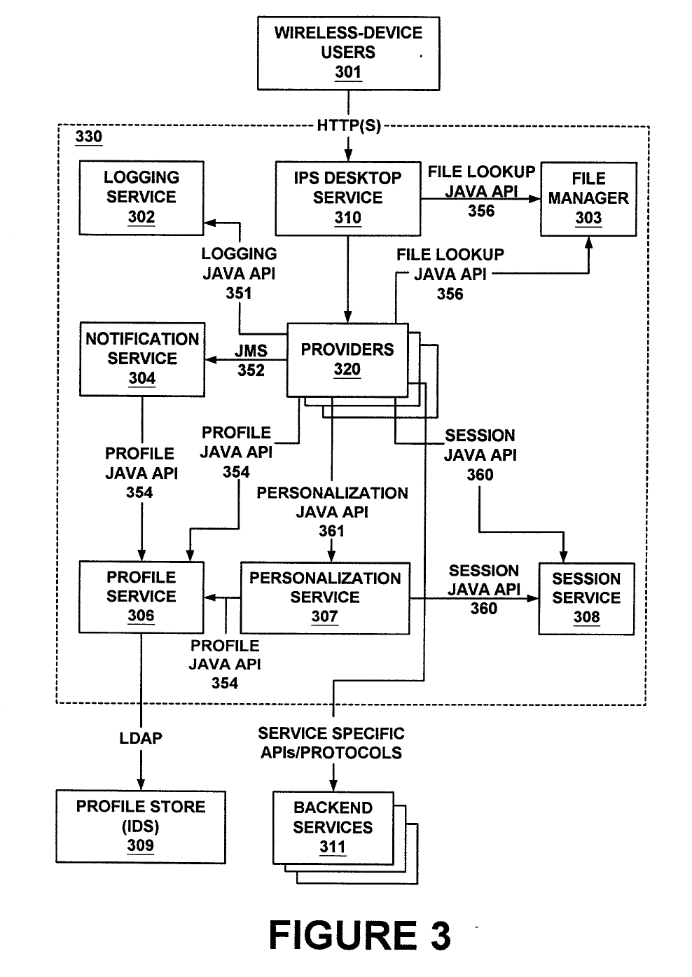

FIG. 3 shows a wireless application environment 330 that allows service providers 320 (e.g., service providers 140-143 of FIG. 1) to provide to wireless-device users the dynamic content that users seek when using the Internet. In one embodiment all of the components of wireless application environment 330, except for service providers 320, are implemented as one or more software program (e.g., wireless portal server 101 of FIG. 1) operable on a computer system (e.g., computer system 200 of FIG. 2). In another embodiment some of the elements of wireless application environment 330 are distributed across multiple computer systems that are communicatively linked.

Continuing with FIG. 3, wireless-device users 301 access the wireless application environment 330 to utilize services and information from service providers 320. Service providers 320 include service providers that provide channels of content (e.g., service providers 140-143 of FIG. 1) and includes service providers that provide other types of services such as, for example, providers of communication services (e.g., the operators of communication networks 130-133 of FIG. 1). Service providers 320 can also include other persons or entities that contribute information and/or services to wireless application environment 330.

Wireless portal environment 332 also includes logging service 302 which communicates with the provider 320 via logging API (Application Program Interface) 351. In this embodiment of the present invention, logging API 351 is implemented as a Java API. Logging API 351 can be implemented in many different physical platforms within a network.

Session service 308 acquires and stores the information peculiar to each communication session, such as what information the user wants to receive during the communication session and the session identification number. Session information is dynamic and primarily includes information that is only stored for short periods of time. Location service 305 communicates with session service 308 via session interface 360. In one embodiment, session service 308 stores location information for use by location service 305.

Profile service 306, via profile interface 354, supplies wireless-device user related information including, for example, static preferences and information peculiar to the wireless-device user's access device (e.g., display size and bandwidth capability). Profile service 306 acquires its profile information from profile store 309 through the use of an LDAP (Lightweight Directory Access Protocol) API. LDAP provides a simple protocol that allows the access and search of directories containing information that is often stored on a variety of incompatible systems.

Personalization service 307 supplies a wide range of user-related information. The user's name and various identity numbers, the user's preferences in a wide array of consumer selections can all be supplied by the personalization service. Profile service 306 and personalization service 307 communicate with each other and with service providers 320 via a profile interface 354 and personalization interface 361.

As discussed above, each service communicates with a provider in accordance with the needs that develop in providing information and services to wireless-device user 301. Every wireless-device user 301 differs in the type of device used to access a wireless network, in the personalized way in which the user prefers to receive information, in the information the user is looking for in any given access session, and in the services the user wants to have made available. Each provider responds by complying with the users' preferences that are stored and can be changed as required by the wireless-device user.

Each of service providers 320 obtains the particular needs of a wireless-device user's communication device and preferred services from profile service 306. The user's desktop preferences, what items the user wants displayed at any given time, are supplied from the desktop service 310. Desktop service 310 couples with file manager 303 and service providers 320 to provide requested services and/or information to wireless-network users 301. User location knowledge is provided to service providers 320 by a location service, 305 that acquires user location information and stores it in anticipation of a query by a provider. Backend services 311 provide additional resources for the wireless application environment.

In one embodiment notification service 304 is the functional component that is primarily operable to couple communications to wireless-device users 301. Notification service 304 is accessed by service providers 320 through interface 352. In one embodiment, interface 352 is a Java Message Service (JMS) interface.

In one embodiment, each of services 302-308 are available to providers 330 through API's 351-354, 356, 358 and 360-361. Though personalization service 307, logging service 302, notification service 304, profile service 306, desktop service 310, session service 308, file manager 303 location service 305 and session service 308 are shown as separate functional blocks within the wireless application environment, individual services may actually be integrated with other services.

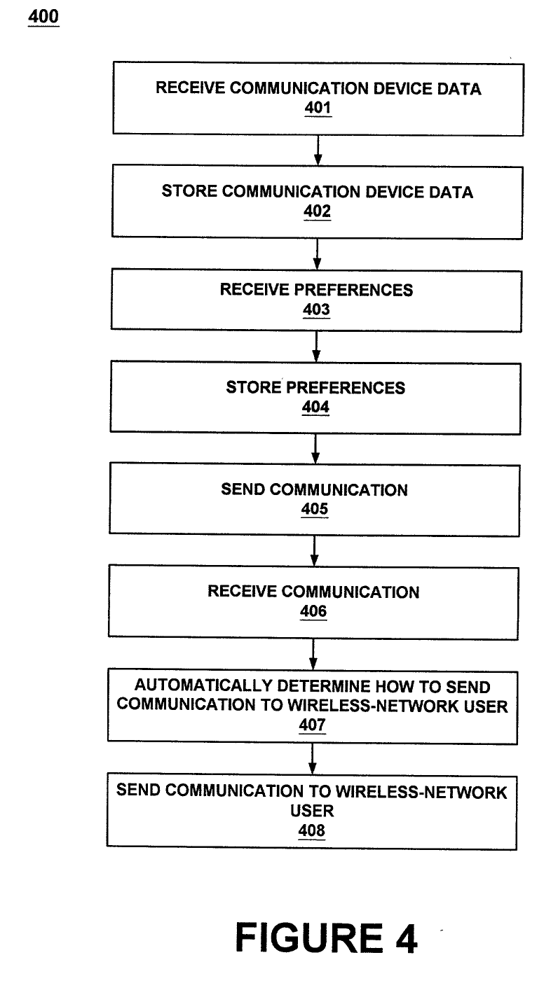

FIG. 4 illustrates a computer-implemented method 400 for communicating using a portal server. In one embodiment, prior to performing the steps of method 400 or prior to or during some or all of the steps of method 400, wireless-device clients are detected and authenticated. Client detection is described in greater detail in U.S. patent application Ser. No. 09/929,477, filed Aug. 13, 2001 entitled Extensible Client Aware Detection in a Wireless Portal System, naming Luu Tran et al. as inventors, which is hereby incorporated by reference in its entirety. Client authentication is described in greater detail in U.S. patent application Ser. No. 09/929,476, filed Aug. 13, 2001 entitled Client Aware Authentication in a Wireless Portal System, naming Luu Tran et al. as inventors, which is hereby incorporated by reference in its entirety.

As shown by step 401, data identifying communication devices that can be used to couple communications to a wireless-network user is received. In the embodiment shown in FIG. 1, wireless portal server 101 includes provision for the wireless-network user to enter data identifying communication devices (communication-device data) that can be used to couple communications to the wireless-network user.

In the embodiment shown in FIG. 3, communication-device data can be entered in the wireless-network user's user profile (profile service 306). More particularly, in one embodiment, the wireless-network user 301 accesses (through desktop service 310) web pages that are forms requesting information relating to communication devices that can be used to reach the wireless-network user 301. The wireless-network user then fills out the forms, indicating the type of device, any associated phone number, or other information necessary to communicate with the communication devices. This information, referred to hereinafter as “communication device data,” can include data identifying the wireless-network user's wireless-communication devices and non-wireless communication devices as well.

As shown by step 402 of FIG. 4, the communication device data is stored. In the embodiment shown in FIG. 2, the communication device data is stored in data storage device 20. In the embodiment shown in FIG. 3, profile service 306 is operable to store communication device data. In one embodiment, communication device data is stored in profile store 309 for access by profile service 306.

Continuing with step 403 of FIG. 4, when a wireless-device user enters data identifying two or more communication devices in step 402, the user is allowed to indicate preferences between the communication devices. In one embodiment, the wireless-device user can indicate on the forms submitted step 401 preferences between communication devices. Alternatively, preferences are indicated on separate web pages that are specifically designed for the entry of preferences.

Referring now to step 404, when the wireless-network user indicates a preference in step 403, the preference is stored as “preference data.” In the embodiment shown in FIG. 2, the preference data is stored in data storage device 20. In the embodiment shown in FIG. 3, the preference data is stored in profile service 306. In one embodiment, preference data is stored in profile store 309 for access by profile service 306.

In one embodiment, the preference data includes preferences relating to the source of the communication, the type of communication device used to send the communication and/or the indicated priority of the communication. For example, the wireless-network user can indicate that all incoming email messages are to go to his desktop computer unless the incoming email is from his boss. Messages from his boss can be routed to his cellular telephone. Similarly, the wireless-device user can indicate that voice communications have a higher priority than email messages, or that messages from a particular communication device have a higher priority.

The preference data can also include static data relating to the wireless-device user. For example, preference data can include the wireless-device user's name, address, age and other characteristics that the user wishes to enter.

As shown by step 405, a communication is then sent to the portal server that indicates a wireless-network user that is to receive the communication. In the embodiment shown in FIG. 1, communications can be sent from any of communication devices 110-118. Also, the communication can be received from other wireless-device users, from service providers, or from entities and/or communication devices outside of the wireless portal server network. The identification of the wireless-device user can take any of a number of different forms. In one embodiment, the wireless-device user's name is used. Alternatively, letters and/or numbers could be used (either exclusively or in addition to the wireless-device user's name).

As shown by step 406 the communication is received at the wireless portal server. In the embodiment shown in FIG. 1, the communication is received at portal server 101. Upon receiving the communication at the portal server (that indicates a wireless-network user that is to receive the communication) the portal server automatically determines how to send the communication to the wireless-network user as shown by step 407. More particularly, the portal server determines a protocol for sending the communication to the wireless-network user. In the present embodiment the communication device data and the preference data is used to determine how to send the communication to the wireless-network user. In the embodiment shown in FIG. 3, notification service 304 is operable to determine the communication device that is to be used to send the communication to the wireless-network user 301. In one embodiment, notification service 306 obtains the communication device data and the preference data from profile service 306 and determines which device should be used by analysis of the communication device data and the preference data.

The communication is then sent to the wireless-network user as shown by step 408. In the embodiment shown in FIG. 1, wireless portal server 101 sends the message to one of communication devices 110-118. In the embodiment shown in FIG. 3, notification service 304 is operable to send the communication to the indicated wireless-device user 301. The transmission can be sent wirelessly (e.g., wireless networks 130-133 of FIG. 1).

In the present embodiment, the message is automatically formatted in a format that is suitable to the communication device that is to receive the message and that is suitable for transmission through any communication networks that will convey the message to the wireless-network user. In one embodiment, message conversion is automatically performed using a computing device such as computer system 200 of FIG. 2. Thus, for example, if a large text message is received that is to be coupled to a communication device having a limited-size display, the text message is converted into the required format. Similarly, if a text message is received and the receiving communication device does not provide for textual display, the text message is converted to the appropriate format. For example, if a text message is to be sent to a radiotelephone that does not have textual display capabilities, the text message is converted into a voice message that is then sent. Similarly, if a text message is received that is to be sent to a facsimile device, the message is reformatted into a format that can be received by the particular facsimile device.

In one embodiment the notification service can be used by other programs operable within either the portal server or within the wireless application environment for communicating with the wireless-device user. For example, a calendar program operable on server 101 of FIG. 1 or operable on one of communication devices 110-118 can automatically send a communication to the wireless-device user (e.g., notification of an upcoming meeting or event).

The method and apparatus of the present invention allows a wireless-network user access to the Internet and allows incoming communications for a wireless-network user to be easily and efficiently coupled to the intended wireless network user. The sender does not have to know how to reach the wireless-network user or where the wireless-network user is located. The wireless-portal server of the present invention automatically couples the communication to the wireless-network user wherever the wireless-network user is located and by the most convenient communication device.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

We claim:

1. A portal server communicatively coupled with at least one wireless network, said portal server communicatively coupled to a plurality of service providers for providing content over channels of said portal server, said portal server, in response to receiving a communication from a client device that indicates a wireless-network user that is to receive said communication, for automatically coupling said communication to said wireless-network user according to preferences indicated by said wireless-network user.

2. The portal server of claim 1 wherein said portal server is a wireless portal server that only provides services to wireless-device users.

3. The portal server of claim 2 wherein said portal server is coupled to a data storage device, said portal server comprising provision for said wireless-network user to enter data identifying communication devices that can be used to couple communications to said wireless-network user, said portal server operable to store said data identifying communication devices in said data storage device.

4. The portal server of claim 1 wherein said portal server is coupled to a data storage device, said portal server further comprising provision for said wireless-network user to enter said preferences and comprising provision for said wireless-network user to change said preferences, said preferences stored in said data storage device.

5. The portal server of claim 4 wherein said portal server comprises a software program that is operable to automatically determine how to couple said communication to said wireless-network user by selecting between said data identifying communication devices according to said preferences to determine a communication device to be used for coupling said communication to said wireless-network user.

6. The portal server of claim 5 wherein said communication device is selected from the group consisting of a personal digital assistant, a radiotelephone, a cellular radiotelephone and a pager.

7. The portal server of claim 5 wherein said communication device is selected from the group consisting of a personal digital assistant, a radiotelephone, a cellular radiotelephone, a pager, a telephone, a computer system and a facsimile machine.

8. The portal server of claim 3 wherein said communication devices that can be used to couple communications to said user comprise at least one communication device that is coupled to said portal server over said at least one wireless network.

9. A method for communicating using a portal server that is coupled to at least one wireless network, said method comprising:
receiving a communication that indicates a wireless-network user that is to receive said communication;
automatically determining a protocol for sending said communication to said wireless-network user; and
sending said communication to said wireless-network user.

10. A method as recited in claim 9 wherein said portal server is a wireless portal server, said method further comprising:
receiving data at said portal server identifying one or more communication devices that can be used to couple communications to said wireless-network user;
storing said data identifying said one or more communication devices;
receiving data from said wireless-network user indicating preferences between said one or more communication devices; and
storing said preferences when said wireless-network user indicates preferences between said one or more communication devices.

11. A method as recited in claim 10 wherein said step of automatically determining a protocol for sending said communication to said wireless-network user further comprises using said data identifying said one or more communication devices and using said preferences to automatically determine said protocol for sending said communication to said wireless-network user.

12. A method as described in claim 11 wherein said communication is coupled to said portal server over said wireless network.

13. A method as described in claim 12 wherein said communication is sent from a client device selected from the group consisting of a personal digital assistant, a radiotelephone, a cellular radiotelephone and a pager.

14. A method as described in claim 11 wherein said communication is coupled from said network server to said wireless-network user over said wireless network.

15. In a computer system including a processor coupled to a bus, and a memory unit coupled to the bus for storing information, a computer-implemented method for communicating using an portal server that is coupled to at least one wireless network, said computer-implemented method comprising:
receiving data at said portal server that identifies one or more communication devices that can be used to couple communications to a wireless-network user;
storing said data identifying said one or more communication devices;
receiving data from said wireless-network user that indicates preferences between said one or more communication devices;
storing said preferences when said wireless-network user indicates preferences between said one or more communication devices;
receiving a communication at said portal server that indicates a wireless-network user that is to receive said communication;
automatically determining a protocol for sending said communication to said user using said data identifying said one or more communication devices and using said preferences; and
sending said communication to said wireless-network user.

16. A computer-implemented method as described in claim 15 wherein said portal server is a wireless portal server and wherein said sending said communication to said wireless-network user further comprises sending said communication to a communication device using said wireless network.

17. A computer-implemented method as described in claim 15 further comprising:
providing channels for said wireless-network user to access data from service providers.

18. A computer readable medium having stored therein a computer program that when executed implements a method for communicating using a portal server comprising:
upon receiving data identifying one or more communication devices that can be used to couple communications to a wireless-network user, storing said data;
upon receiving preferences between said one or more communication devices, storing said preferences; and
upon receiving a communication that indicates a wireless-network user that is to receive said communication, automatically determining a protocol for sending said communication to said wireless-network user and sending said communication to said wireless-network user, said determination made using said data identifying said one or more communication devices and using said preferences.

19. The computer-readable medium of claim 18 wherein said method further comprises providing channels for said wireless-network user to access data from service providers.

20. The computer-readable medium of claim 19 wherein sending said communication to said wireless-network user further comprises sending said communication to a communication device using said wireless network.
